(19) United States
(12) Patent Application Publication
(10) Pub. No.: US 2008/0204239 A1
(43) Pub. Date: Aug. 28, 2008

(54) Apparatus, system and/or method for wirelessly securing and/or for wirelessly monitoring an article

(76) Inventors: Christopher Marszalek, Plainfield, IL (US); Daniel Horvath, Plainfield, IL (US); Frank Harwath, Chicago, IL (US); Jim Groth, Poplar Grove, IL (US)

Correspondence Address: PATENTS+TMS, P.C., 2849 W. ARMITAGE AVE., CHICAGO, IL, 60647, US

(21) Appl. No.: 11/711,939

(22) Filed: Feb. 28, 2007

(51) Int. Cl. G08B 13/14

(52) U.S. Cl. 340/572.1

(57) ABSTRACT

An apparatus, a system and a method wirelessly secure and wirelessly monitor an article. The apparatus, the system and the method operate as an alarm system that may prevent a theft and/or a removal of the article from a defined perimeter and/or defined perimeters. The apparatus, the system and the method may have one or more alarm boxes that monitor one or more heads. One or more of the heads may be attached to and/or may be electronically connected to one or more articles, such as, for example, portable electronic equipment. The articles be provided on display in and/or may be used, manipulated and/or transported by consumers in a store environment. The alarm box may be installed in close proximity to a display stand of the article. The alarm box may charge components of the head and/or the article while the head and/or the article are located on the display stand of the article. The head may power the article while the article is not connected to a power supply of the display stand and/or a power supply of the alarm box. The alarm box and/or the store environment may have one or more fence drivers. The fence driver may create one or more zones. The head has a fence detector that may detect whether or not the head and/or the article is located in a position within the zone. The fence drivers and/or one or more of the zones may be configured to control locations at which the head and/or the article may be used without triggering an alarm event.

### BACKGROUND OF THE INVENTION

The present invention generally relates to an apparatus, a system and/or a method for wirelessly securing and/or for wirelessly monitoring an article. More specifically, the present invention relates to an apparatus, a system and/or a method that may operate as an alarm system that may prevent a theft and/or a removal of the article from a defined perimeter and/or defined perimeters. The apparatus, the system and/or the method may have one or more alarm boxes that may monitor one or more heads attached to the article. One or more of the heads may be electronically connected to one or more of the articles, such as, for example, portable electronic equipment. The articles may be on display and/or may be used, manipulated, tested and/or transported by consumers in a store environment, such as a retail store.

The alarm box may be installed in proximity to a display stand of the article. The alarm box may charge components of the head and/or the article while the head and/or the article are located on the display stand of the article. The head may power the article while the article is located away from the display stand and/or away from the alarm box. The alarm box and/or the retail store environment may have one or more fence drivers. The fence driver may create one or more zones. The head may have a fence detector that may detect whether or not the head and/or the article is located within one or more of the zones. The fence drivers and/or one or more of the zones may be configured to control locations at which the head and/or the article may be used without entering an alarm mode.

It is generally known that retailers of articles provide samples of the articles that allow consumers to interact with the articles. The samples may be located on or near a display for the article wherein pricing information and product availability may be displayed. Further, power connections, data connections and/or security tethers for the article may be provided at the display. Of course, the samples may be expensive to replace if removed, stolen or otherwise damaged. Further, the presence of samples may be essential to sales of the article. Therefore, it is important for retailers to maintain an availability of the samples and/or to control a location of the samples to allow consumers to have exposure to the articles.

As a result, known security systems have been provided and/or are used by retailers to secure a sample to its display and/or to alert security personnel of theft, of destruction and/or of tampering of the sample. The known security systems are typically electronically connected by means of wires to sensors attached to the samples. The connections may be used to power the samples and/or to communicate with a main box at or near the display. However, the known security systems may be difficult to install, cosmetically unappealing the consumers and/or may be difficult to modify to accommodate and/or to secure additional samples. Moreover, while using samples secured by the known security systems, the samples remain tethered to the display, and the consumers have little freedom to manipulate, to transport, to use, to test and/or to enjoy the sample.

A need, therefore, exists for an apparatus, a system and/or a method for wirelessly securing and/or for wirelessly monitoring an article. Additionally, a need exists for an apparatus, a system and/or a method that operate as an alarm system that may prevent a theft and/or a removal of the article from a defined perimeter and/or defined perimeters. Further, a need exists for an apparatus, a system and/or a method that provide an alarm box that may wirelessly monitor a head attached to the article. Still further, a need exists for an apparatus, a system and/or a method that may provide an audible indication and/or a visual indication on the alarm box and/or on the head that an alarm event has been triggered. Still further, a need exists for an apparatus, a system and/or a method that may provide different audible tones and/or visual indicators on the alarm box and/or the head before, during and/or after the alarm event. Still further, a need exists for an apparatus, a system and/or a method that may use the alarm box to power and/or to charge the head and/or the article when the head and/or the article are located on a display stand for the article. Still further, a need exists for an apparatus, a system and/or a method that may use the head to power the article when the article is located away from the display stand for the article. Still further, a need exists for an apparatus, a system and/or a method that may alert a user of the article and/or security personnel of movement of the head and/or the article into and/or out of one or more zones.

### SUMMARY OF THE INVENTION

The present invention generally relates to an apparatus, a system and/or a method for wirelessly securing and/or for wirelessly monitoring an article. More specifically, the present invention relates to an apparatus, a system and/or a method that operate as an alarm system that may prevent a theft and/or a removal of the article from a defined perimeter and/or defined perimeters. The apparatus, the system and/or the method may have one or more alarm boxes that may monitor one or more heads. One or more of the heads may be attached to and/or may be electronically connected to one or more of the articles. The articles may be portable electronic equipment, such as, for example, cellular telephones, mp3 players, cameras, camcorders, PDAs, gaming devices and/or the like. Further, the articles may be on display and/or may be used, manipulated tested and/or transported by consumers in a retail store environment.

The alarm box may have a power management system, a horn, a visual alert, a reset key, a code modifier, a power distribution system, a fence driver and/or a radio receiver. The alarm box may be installed in proximity to a display stand of the article. The head may have a power management system, a horn, a visual alert, a radio transmitter, a reset key, a code modifier, a fence detector, a sensor control and/or a senor. The power management system and/or the power distribution system of the alarm box may charge components of the head and/or the article while the head and/or the article are located on the display stand of the article. The display stand of the article may provide one or more electrical connections, data connections and/or the like between the alarm box and the head and/or the article. The power management system of the head may power the article while the article is located away from the display stand and/or away from the alarm box. Further, the article may power itself while the article is located away from the display stand.

The fence driver of the alarm box may be located inside the alarm box. Further, the fence driver may be provided at a position separate from the alarm box. The fence driver may create one or more zones. The zones may be defined by a transmitting medium such as, for example, electromagnetic energy, infrared light, ultrasonics, infrasonics, visible light and/or the like. The fence driver may be configured to control the size of the zone. The fence driver may be, for example, a tape conductor, an antenna, an infrared light transmitter and/or the like. The fence detector of the head may detect a presence of and/or an absence of the transmitting medium that defines the zone while the head is located at a position inside of and/or outside of the zone. The fence detector may detect electromagnetic radiation, infrared light, sound and/or the like. The zone may be, for example, planar, hemispherical and/or spherical in shape. The fence detector of the head may be programmed to enter an alarm mode when the head is located in a position outside of one or more of the zones and/or when the head is located in a position inside of one or more of the zones. The fence drivers and/or one or more of the zones may be configured to control locations where the head and/or the article may be used without entering an alarm mode.

Upon entering an alarm mode, an alarm of the head may sound, the horn of the head may be activated and/or the visual alert of the head may be activated to notify a user of the article and/or security personnel that the article and/or the head is located in an undesirable position defined as being in a position outside one or more of the zones and/or in a position inside one or more of the zones. Further, the radio transmitter of the head may be activated to communicate with the radio receiver of the alarm box. After the alarm box receives a communication from the radio transmitter of the head, an alarm of the alarm box, the horn of the alarm box and/or the visual alert of the alarm box may be activated to notify the user of the article and/or the security personnel that the article and/or the head is located in the undesirable position. The reset key and/or the code modifier of the alarm box and/or of the head may be activated to disable the alarm, the horn and/or the visual alert of the main box and/or of the peripheral box.

A frequency of the transmitting medium and/or of an electromagnetic signal communicated between the head and the alarm box may be modified with frequency hopping to secure the communications used by the apparatus, the system and/or the method. Further, the frequency of the transmitting medium may be modified to activate the reset key and/or the code modifier of the head.

To this end, in an embodiment of the present invention, a system for wirelessly securing an article is provided. The system has an alarm box having a fence driver, a receiver, a first alerting means, a reset key and a power distribution system wherein the fence driver creates a zone defined by a transmitting medium having a carrier signal wherein the zone extends to a perimeter around the fence driver wherein the receiver receives a communication relating to an alarm event wherein the first alerting means provides a signal indicative of the alarm event to the system. Further, the system has a head having a fence detector, a transmitter, a second alerting means, a sensor and a power management system wherein the head is attached to the article wherein the fence detector detects a presence of the carrier signal of the transmitting medium wherein the sensor detects a detachment of the head from the article wherein a detection of an absence of the carrier signal of the transmitting medium by the fence detector initiates the alarm event wherein a detection of the detachment of the head from the article by the sensor initiates the alarm event wherein the transmitter of the head communicates the alarm event to the receiver of the alarm box wherein the second alerting means of the head provides a signal indicative of the alarm event.

In an embodiment, the system has a battery connected to the power management system wherein the battery provides power to the head.

In an embodiment, the system has a visual indicator associated with the alarm box wherein the visual indicator provides a visual signal indicative of the alarm event.

In an embodiment, the system has an audible indicator associated with the head wherein the audible indicator provides an audio signal indicative of the alarm event.

In an embodiment, the reset key of the alarm box is modified by a code modification.

In an embodiment, the carrier signal of the transmitting medium is modified with frequency hopping.

In an embodiment, the system has means for adjusting a distance between the fence driver of the alarm box and the perimeter of the zone.

In an embodiment, the system has a reset key associated with the head wherein the reset key terminates the alarm event.

In an embodiment, the system has a wired bypass associated with the alarm box wherein the wired bypass terminates the alarm event.

In another embodiment of the present invention, a system for wirelessly monitoring an article is provided. The system has an alarm box having a radio transceiver, a first alerting means and a computer interface wherein the radio transceiver communicates information relating to an alarm event wherein the first alerting means provides a signal indicative of the alarm event to the system via the computer interface. Further, the system has a head having a radio transceiver, a second alerting means and a sensor wherein the head is attached to the article wherein the sensor detects a detachment of the head from the article wherein detection of the detachment of the head from the article by the sensor triggers the alarm event wherein the radio transceiver of the head communicates the alarm event with the radio transceiver of the alarm box wherein the second alerting means provides a signal indicative of the alarm event. Further, the system has a computer connected to the computer interface of the alarm box.

In an embodiment, the system has control software associated with the computer wherein the control software monitors the alarm event.

In an embodiment, the system has a sensor control associated with the head wherein the sensor control adjusts a sensitivity of the sensor.

In an embodiment, the system has a power management system associated with the head wherein the power management system powers the head.

In an embodiment, the system has an inventory code associated with the alarm box wherein the inventory code corresponds with the head.

In an embodiment, the system has a data management system associated with the head that manages information communicated between the radio transceiver of the alarm box and the radio transceiver of the head.

In another embodiment of the present invention, a method for wirelessly securing an article is provided. The method has the step of providing a fence driver that creates a zone defined by a transmitting medium having a carrier signal wherein the zone extends to a perimeter around the fence driver. Further, the method has the step of attaching a head to the article wherein the head has a fence detector, an alerting means and a sensor wherein the fence detector detects a presence of the carrier signal of the transmitting medium and the sensor detects an attachment of the head to the article wherein a detection of the presence of the carrier signal of the transmitting medium by the fence detector initiates an alarm event wherein a detection of a detachment of the head from the article by the sensor initiates the alarm event. Further, the method has the step of activating the fence detector and the sensor.

In an embodiment, the method has the step of adjusting a distance between the fence driver and the perimeter of the zone.

In an embodiment, the has the step of terminating the alarm event with a reset key associated with the head.

In an embodiment, the method has the step of providing power to the article with a battery associated with the head.

In an embodiment, the method has the step of modifying a frequency of the carrier signal.

It is, therefore, an advantage of the present invention to provide an apparatus, a system and/or a method for wirelessly securing and/or for wirelessly monitoring an article.

Another advantage of the present invention is to provide an apparatus, a system and/or a method for wirelessly securing and/or for wirelessly monitoring an article that operate as an alarm system that may prevent a theft and/or a removal of the article from a defined perimeter and/or defined perimeters.

And, another advantage of the present invention is to provide an apparatus, a system and/or a method for wirelessly securing and/or for wirelessly monitoring an article that has one or more alarm boxes that may monitor one or more heads. The heads may be attached to and/or may be electronically connected to one or more articles, such as, for example, clothing, sporting goods, toys, groceries, cellular telephones, mp3 players, cameras, camcorders, PDAs, gaming devices, automobiles, heavy equipment, vehicles, and/or the like.

Yet another advantage of the present invention is to provide an apparatus, a system and/or a method for wirelessly securing and/or for wirelessly monitoring an article wherein the article may be on display in and/or may be used, manipulated and/or transported by consumers in a retail store environment.

A further advantage of the present invention is to provide an apparatus, a system and/or a method for wirelessly securing and/or for wirelessly monitoring an article that may provide audible and visual indication on the alarm box and/or on the head that an alarm event has been triggered.

Moreover, an advantage of the present invention is to provide an apparatus, a system and/or a method that may provide different audible tones and visual indicators on the alarm box and/or the head before, during and/or after the alarm event.

And, another advantage of the present invention is to provide an apparatus, a system and/or a method for wirelessly securing and/or for wirelessly monitoring an article that may use the alarm box to power and/or to charge the head and/or the article when the head and/or the article are located on a display stand for the article.

Yet another advantage of the present invention is to provide an apparatus, a system and/or a method for wirelessly securing and/or for wirelessly monitoring an article that may use the head to power the article when the article is located away from the display stand for the article.

Another advantage of the present invention is to provide an apparatus, a system and/or a method for wirelessly securing and/or for wirelessly monitoring an article that may alert a user of the article and/or security personnel of movement of the head and/or the article into and/or out of one or more zones.

Yet another advantage of the present invention is to provide an apparatus, a system and/or a method for wirelessly securing and/or for wirelessly monitoring an article having an alarm box that may have a power management system, a horn, a visual alert, a reset key, a code modifier, a power distribution system, a fence driver and/or a radio receiver.

A still further advantage of the present invention is to provide an apparatus, a system and/or a method for wirelessly securing and/or for wirelessly monitoring an article having a head that may have a power management system, a horn, a visual alert, a radio transmitter, a reset key, a code modifier, a fence detector, a sensor control and/or a senor.

Moreover, an advantage of the present invention is to provide an apparatus, a system and/or a method for wirelessly securing and/or for wirelessly monitoring an article wherein the power management system and/or the power distribution system of the alarm box may charge components of the head and/or the article while the head and/or the article are located on the display stand of the article.

And, another advantage of the present invention is to provide an apparatus, a system and/or a method for wirelessly securing and/or for wirelessly monitoring an article wherein the display stand of the article may provide one or more electrical connections, data connections and/or the like between the alarm box and the head and/or the article.

Yet another advantage of the present invention is to provide an apparatus, a system and/or a method for wirelessly securing and/or for wirelessly monitoring an article wherein the power management system of the head may power the article while the article is located away from the display stand and/or away from the alarm box.

Moreover, an advantage of the present invention is to provide an apparatus, a system and/or a method for wirelessly securing and/or for wirelessly monitoring an article that upon entering an alarm mode, the horn and/or the visual alert of the head may be activated to notify a user of the article and/or security personnel that the article and/or the head is in an undesirable location defined as being outside one or more of the zones and/or inside one or more of the zones.

And, another advantage of the present invention is to provide an apparatus, a system and/or a method for wirelessly securing and/or for wirelessly monitoring an article wherein the reset key and/or the code modifier of the alarm box and/or of the head may be activated to disable the horn and/or the visual alert of the main box and/or of the peripheral box.

Yet another advantage of the present invention is to provide an apparatus, a system and/or a method for wirelessly securing and/or for wirelessly monitoring an article wherein the article may be any item and/or items of any size displayed in any store environment, such as, for example, a retail store, a grocery store, a car dealership, a wholesale warehouse, a department store, a jewelry store, an electronics store and/or the like.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system for wirelessly securing and/or for wirelessly monitoring an article in an embodiment of the present invention.

FIG. 2 illustrates a black box diagram of a system for wirelessly securing and/or for wirelessly monitoring an article in an embodiment of the present invention.

FIG. 3 illustrates a black box diagram of a system for wirelessly securing and/or for wirelessly monitoring an article in an embodiment of the present invention.

FIG. 4 illustrates a black box diagram of a system for wirelessly securing and/or for wirelessly monitoring an article in an embodiment of the present invention.

FIG. 5 illustrates a black box diagram of a system for wirelessly securing and/or for wirelessly monitoring an article in an embodiment of the present invention.

### DETAILED DESCRIPTION OF THE PRESENTLY PREFERRED EMBODIMENTS

The present invention generally relates to an apparatus, a system and/or a method for wirelessly securing and/or for wirelessly monitoring an article. More specifically, the present invention relates to an apparatus, a system and/or a method that operate as an alarm system that may prevent a theft and/or a removal of the article from a defined perimeter and/or defined perimeters. The apparatus, the system and/or the method may have one or more alarm boxes that may monitor one or more heads. One or more of the heads may be attached to and/or may be electronically connected to one or more articles. The articles may be portable electronic equipment. Further, the articles may be on display in and/or may be used, manipulated and/or transported by consumers in a store environment, such as a retail store.

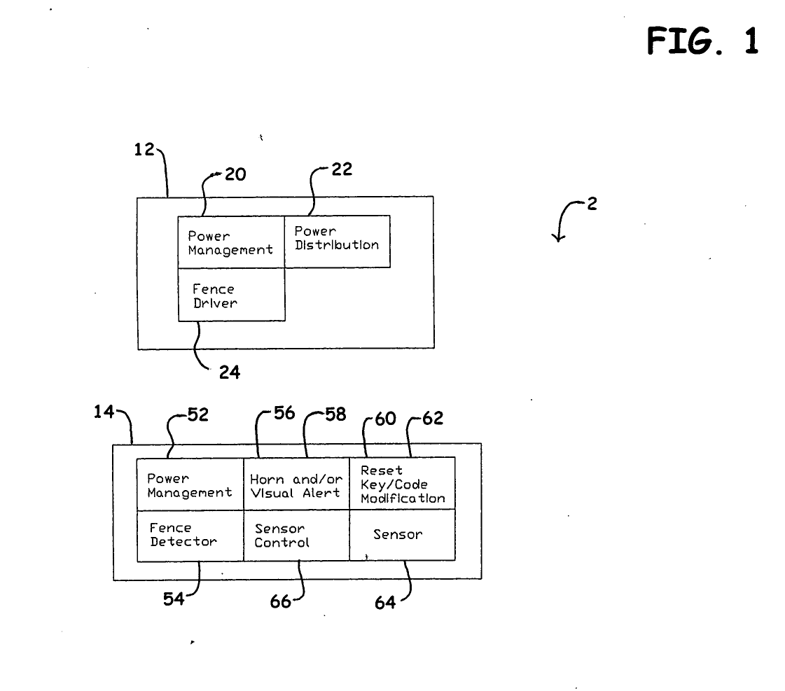

Referring now to the drawings wherein like numerals refer to like parts, FIGS. 1-5 illustrate systems 2, 4, 6, 8, 10, respectively, for wirelessly securing and/or for wirelessly monitoring an article in embodiments of the present invention. In an embodiment, the article (not shown) may be portable electronic equipment, such as, for example, cellular telephones, laptop computers, mp3 players, cameras, camcorders, PDAs, gaming devices and/or the like. The present invention should not be deemed as limited to a specific embodiment of the article. It should be understood that the article may be any article sold and/or displayed in a store environment as known to one having ordinary skill in the art.

FIGS. 1-5 illustrate an alarm box 12. The alarm box 12 may be, for example, a housing, a panel and/or an enclosure for components and/or electronic equipment. The alarm box 12 may be placed and/or mounted on and/or near a display (not shown) for the article. The alarm box 12 may be electrically connected to a source of power, such as, for example, an AC power outlet. The alarm box 12 may have one or more components for wirelessly securing and/or for wirelessly monitoring an article. The alarm box 12 may be formed to allow one or more tethering connections and/or electrical connections with one or more of the components, with one or more sources of power, with one or more computers and/or with one or more displays. It should be understood that the alarm box 12 may be any housing, panel and/or enclosure for electronic equipment as known to one having ordinary skill in the art.

FIGS. 1-5 illustrate a head 14 that may be, for example, a housing and/or an enclosure for electronic equipment. The head 14 may be securely mounted on, securely attached to and/or removably attached to the article. The head 14 may be sized to attach to the article without interfering with a normal operation of the article. The head 14 may be electrically connected to a source of power, such as, for example, the alarm box 12 and/or the AC power outlet. The head 14 may have a tethering connection with the display and/or the alarm box 12. The head 14 may be electrically connected to the article to power the article and/or to communicate data with the article. The head 14 may have one or more components for wirelessly securing and/or for wirelessly monitoring an article. It should be understood that the head 14 may be any housing and/or enclosure for electronic equipment and/or for being securely mounted on, securely attached to and/or removably attached to the article as known to one having ordinary skill in the art.

The alarm box 12 may have a power management system 20 and/or a power distribution system 22 as shown in FIGS. 1-5. The power management system 20 of the alarm box 12 may power the alarm box 12, the components of the alarm box 12, the head 14 and/or the article. The power management system 20 of the main box may have, for example, an AC adapter for converting, transforming and/or for conditioning a voltage, a current and/or a frequency of the power source for use by the alarm box 12, the components of the alarm box 12, the head 14 and/or the article. The power distribution system 22 of the alarm box 12 may distribute power to the alarm box 12, to the components of the alarm box 12, to the head 14 and/or to the article. The power management system 20 of the alarm box 12 and/or the power distribution system 22 of the alarm box may have one or more batteries for supplying power to the alarm box 12, to the components of the alarm box 12, to the head 14 and/or to the article when power is not available from the power source, such as, for example, during a power outage. The batteries of the alarm box may be, for example, rechargeable batteries. It should be understood that the power management system 20 and/or the power distribution system 22 may be any components for managing and/or for distributing power as known to one having ordinary skill in the art.

The alarm box 12 may have a fence driver 24 as shown in FIGS. 1-4. The fence driver 24 may create a zone defining a perimeter about the fence driver 24. The zones may be defined by a transmitting medium, such as, for example, electromagnetic energy, infrared light, ultrasonics, infrasonics, visible light and/or the like. The transmitting medium may have one or more carrier signals that may communicate information from the fence driver 24 to the head 14. One or more of the carrier signals may be modified from the alarm box 12 to activate one or more functions of the head, such as for example, to reset the alarm state, to arm the head 14, to disarm the alarm event, to activate a sleep mode and/or the like. Two or more of the carrier signals may be used to create a code that may make the systems 2, 4, 6, 8, 10 less vulnerable to defeat. The information may be digital and/or may be applied to the one or more of the carrier signals by transmission means, such as, for example, on/off shift keying, frequency shift keying and/or the like. Further, one or more control tones may be added to the one or more of the carrier signals by, for example, amplitude modulation, by frequency modulation and/or the like. The zones may be, for example, linear, planar, hemispherical and/or spherical in shape. The fence driver 24 may be configured to control the size of and/or the location of the zone and/or the perimeter of the zone. The fence driver 24 may be, for example, a tape conductor, an antenna, an infrared light transmitter and/or the like. Further, the fence driver 24 may be used in the systems 2, 4, 6, 8 in positions and/or locations outside of the alarm box 12. The fence driver 24 may have its own enclosure and/or may be situated apart from the alarm box 12. It should be understood that the fence driver 24, the transmitting medium and/or the carrier signals may be any driver, medium and/or signal as known to one having ordinary skill in the art. The present invention should not be deemed as limited to a specific embodiment of the fence driver 24.

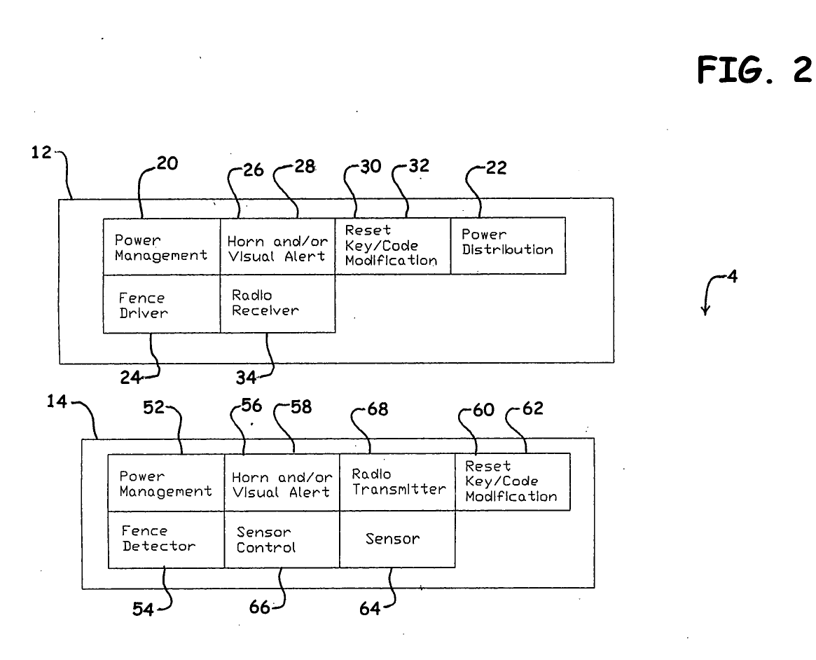

The alarm box 12 may have an alarm having a horn 26, a visual alert 28, a reset key 30 and/or a code modification 32 as shown in FIGS. 2-5. The horn 26 of the alarm box 12 may be activated during an alarm event producing an audible sound that may be heard by anyone in a proximity of a range of the horn 26. The horn 26 may be any instrument for creating sound, such as, for example, a pneumatic horn, a speaker and/or the like. The visual alert 28 of the alarm box may be used to visually communicate information to a user of the alarm box 12, the head 14 and/or the article. The visual alert 28 may communicate information, such as, for example, a status of the alarm box 12, of the head 12 and/or of the article, a status of an alarm event, a status of battery power of the alarm box 12, of the head 12 and/or of the article, a status of an alarm state and/or the like. The visual alert 28 may be any means for visual communication, such as, for example, an electronic screen, a light emitting diode (LED) and/or the like. Further, the alarm may be silent and may notify users of the alarm box 12 and/or security personnel of the alarm event with a silent notification, such as, for example an electronic communication. It should be understood that the alarm of the alarm box, the horn 26 of the alarm box 12 and/or the visual alert 28 of the alarm box 12 may be any means for communicating information related to an alarm event as known to one having ordinary skill in the art. The present invention should not be deemed as limited to a specific embodiment of the alarm, the horn 26 and/or of the visual alert 28.

The reset key 30 of the alarm box 12 may be used to disarm an alarm event in both the alarm box 12 and/or in the head 14. A user of the alarm box 12 may enter the reset key 30 into the alarm box 12 to disarm an alarm event in the alarm box 12 and/or in the head 14. The reset key 30 may be, for example, an electronic key. The reset key 12 may be used to arm the alarm box 12 and/or to arm the head 14. The reset key 30 may be activated remotely by a user of the alarm box 12 to arm and/or to disarm the alarm box 12 and/or the head 14. The code modification 32 may be used to reprogram the reset key 30 in an event, such as, for example, if the reset key 30 is compromised. It should be understood that the reset key 30 of the alarm box 12 and/or the code modification 32 of the alarm box 12 may be any electronic key for arming and/or for disarming the alarm box 12 and/or the head 14 and/or any means for modifying the electronic key as known to one having ordinary skill in, the art. The present invention should not be deemed as limited to a specific embodiment of the reset key 30 and/or of the code modification 32.

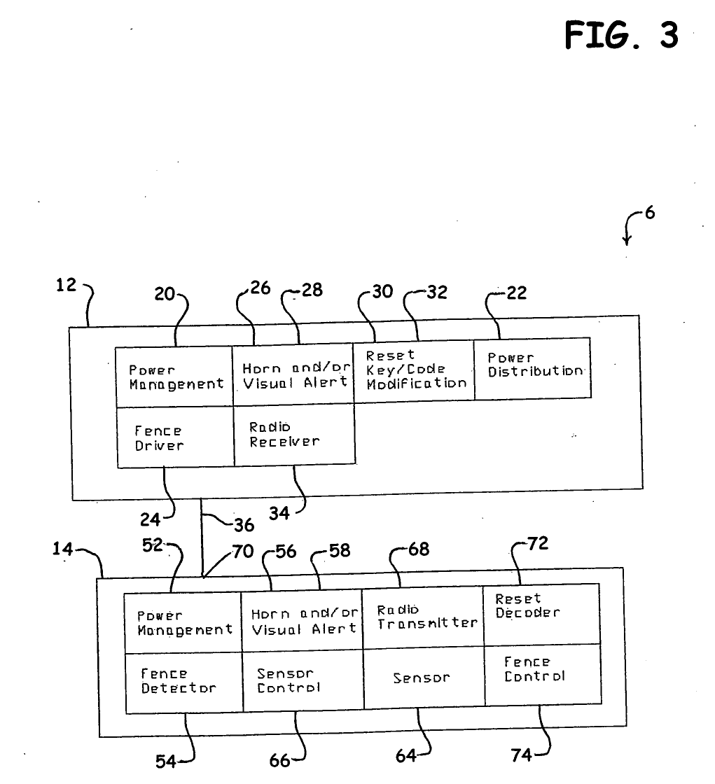

The alarm box 12 may have a radio receiver 34 as shown in FIGS. 2 and 3. The radio receiver 34 of the alarm box 12 may be used to receive a radio transmission from the head 14. The radio transmission from the head 14 may include information relating to, such as, for example, a status of the alarm event, of the head 14 and/or of the article and/or a location of the head 14 and/or the article. The radio receiver 34 may be any receiver for receiving radio transmission from a radio transmitter. It should be understood that the radio receiver 34 of the alarm box 12 may be any means for receiving the radio transmission as known to one having ordinary skill in the art. The present invention should not be deemed as limited to a specific embodiment of the radio receiver 34.

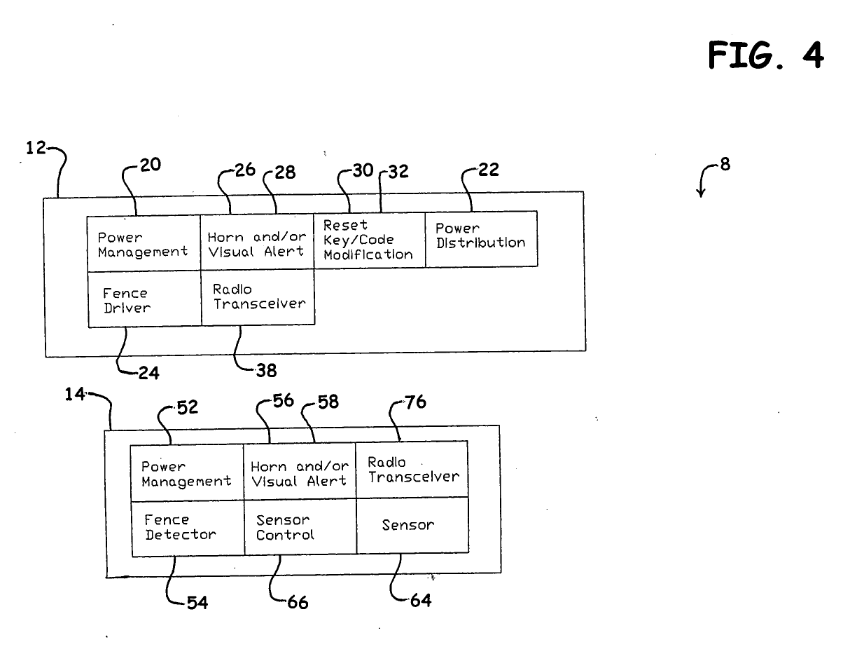

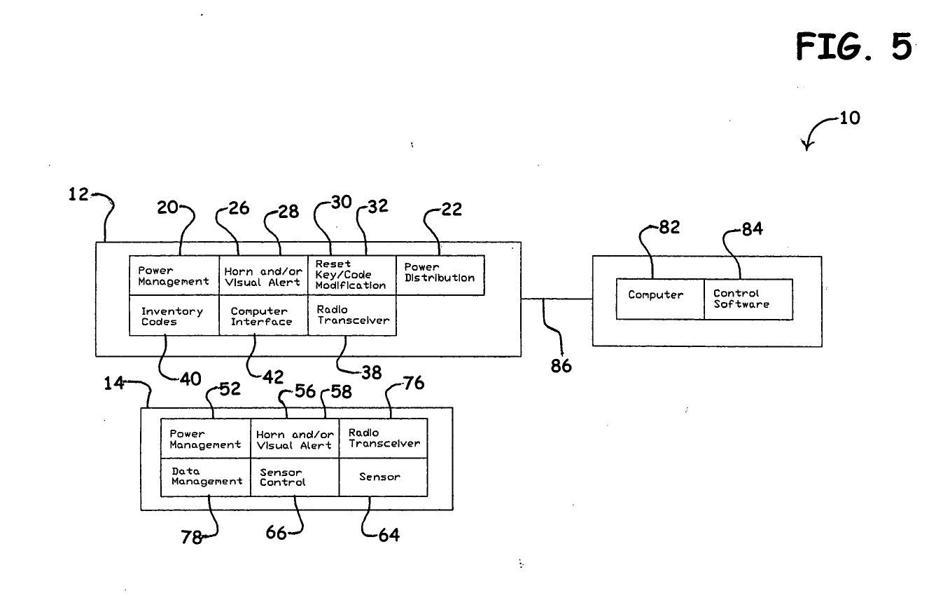

The alarm box 12 may have a radio transceiver 38 as shown in FIGS. 4 and 5. The radio transceiver 38 of the alarm box 12 may be used to transmit and/or to receive a radio transmission to and/or from the head 14. The radio transmission to and/or from the head 14 may include information relating to, such as, for example, a status of an alarm event, of the alarm box 12, of the head 14 and/or of the article and/or a location of the head 14 and/or the article. The radio transceiver 38 may also transmit and/or may receive information that disarms and/or alarms the systems 8, 10. The radio transceiver 38 may be any transceiver for transmitting and/or for receiving the radio transmission. It should be understood that the radio transceiver 38 of the alarm box 12 may be any means for transmitting and/or for receiving the radio transmission as known to one having ordinary skill in the art. The present invention should not be deemed as limited to a specific embodiment of the radio transceiver 38.

The alarm box 12 may have inventory codes 40 and/or a computer interface 42 as shown in FIG. 5. The inventory codes 40 of the alarm box 12 may be related to an inventory of, for example, a retail store in which the alarm box 12 may be located. The inventory codes 40 may be stored electronically in the alarm box 12. The alarm box 12 may use the inventory codes 40 to monitor, to secure and/or to track inventory throughout the retail store. Further, the alarm box 12 may use the inventory codes 40 to monitor, to secure and/or to track articles coupled with one or more of the heads 14. The alarm box 12 may be connected to a computer 82 with control software 84 via a data connection 86. The computer 82 and/or the control software 84 may be any computer and/or software used to monitor, to secure and/or track one or more of the articles and/or the inventory with the system 10. The data connection 86 may be wired and/or may have a wireless connection for linking the computer interface 42 of the alarm box 12 with the computer 82, such as, for example, a USB cable, an ethernet cable, a wi-fi connection and/or the like.

The alarm box 12 may also be connected to the computer 82 via a network, such as, for example a local area network (LAN), the Internet and/or the like. It should be understood that the inventory codes 40, the computer interface 42, the data connection 86, the computer 82 and/or the control software 84 may be any code or codes, interface, connection, computer and/or software for monitoring, for securing and/or for tracking one or more of the heads 14, one or more of the articles and/or the inventory as known to one having ordinary skill in the art. The present invention should not be deemed as limited to a specific embodiment of the inventory codes 40, the computer interface 42, the data connection 86, the computer 82 and/or the control software 84.

The alarm box 12 may have a wired bypass 36 for resetting and/or disarming the alarm event. The wired bypass 36 may be an electrical wire that may transmit the reset key 30 and/or the code modification 32 to the head 14. The wired bypass 36 may extend from the alarm box 12 to the display and/or to the head 14. The wired bypass 36 may be inserted into a wired bypass connection 70 in the head 14 to disable and/or to disarm the alarm event. Further, the wired bypass 36 may be inserted into the wired bypass connection 70 in the head 14 to transmit the reset key 30 and/or the code modification 32 to the head 14. It should be understood that the wired bypass 36 and/or the wired bypass connection 70 may be any means for transmitting the reset code 30 and/or the code modification 32 to the head 14 as known to one having ordinary skill in the art. The present invention should not be deemed as limited to a specific embodiment of the wired bypass 36.

The head 14 may have a power management system 52 as shown in FIGS. 1-5. The power management system 52 of the head 14 may power the head 14, the components of the head 14 and/or the article. The power management system 52 of the head 14 may have one or more batteries for supplying power to the components of the head and/or to the article when the head 14 and/or the article are not connected to the alarm box 12 and/or to the display. The batteries may be, for example, rechargeable batteries. It should be understood that the power management system 52 of the head 14 may be any system for managing and/or for distributing power as known to one having ordinary skill in the art.

The head 14 may have a fence detector 54 as shown in FIGS. 1-4. The fence detector 54 may detect the position of the head 14 and/or of the article within and/or outside the zone defining the perimeter about the fence driver 24. The fence detector 54 may determine the position of the head 14 and/or of the article detecting the transmitting medium. The fence detector 54 may be configured to detect the presence of the transmitting medium and/or the absence of the transmitting medium. The fence detector 54 may be, for example, a tape conductor, an antenna, an infrared light detector and/or the like. It should be understood that the fence detector 54 may be any detector capable of detecting the presence and/or the absence of the transmitting medium as known to one having ordinary skill in the art. The present invention should not be deemed as limited to a specific embodiment of the fence detector 54.

The head 14 may have an alarm, a horn 56 and/or a visual alert 58 as shown in FIGS. 1-5. The alarm and/or the horn 56 of the head 14 may be activated during an alarm event producing an audible sound that may be sounded to be audible in a proximity of a range of the horn 56. The horn 56 may be any instrument for creating sound, such as, for example, a pneumatic horn, a speaker and/or the like. The visual alert 58 of the head 14 may be activated during an alarm event to visually communicate information to a user of the head 14 and/or the article. The visual alert 58 may communicate information, such as, for example, the status of the alarm box 12, of the head 12 and/or of the article, the status of an alarm event, the status of battery power of the alarm box 12, of the head 14 and/or of the article, a status of the alarm state and/or the like. The visual alert 58 may be any means for visual communication, such as, for example, an electronic screen, a light emitting diode (LED) and/or the like. It should be understood that the alarm of the head 14, the horn 56 of the head 14 and/or the visual alert 58 of the head 14 may be any means for communicating information as known to one having ordinary skill in the art. The present invention should not be deemed as limited to a specific embodiment of the alarm, of the horn 56 and/or of the visual alert 58.

The head 14 may have a reset key 60 and/or a code modification 62 as shown in FIGS. 1 and 2. The reset key 60 of the head 14 may be used to disarm an alarm event in the alarm box 12 and/or in the head 14. A user of the head 14 may enter the reset key 60 into the head 14 to disarm the alarm event in the alarm box 12 and/or in the head 14. The reset key 60 may be, for example, an electronic key. The reset key 60 may be used to arm the alarm box 12 and/or to arm the head 14. The reset key 60 may be activated remotely by a user of the head 14 to arm and/or to disarm the alarm box 12 and/or the head 14. The code modification 62 may be used to reprogram the reset key 60 in an event, such as, for example, when the reset key 60 is compromised. It should be understood that the reset key 60 of the head 14 and/or the code modification 62 of the head 14 may be any electronic key for arming and/or for disarming the alarm box 12 and/or the head 14 and/or any means for modifying the electronic key as known to one having ordinary skill in the art. The present invention should not be deemed as limited to a specific embodiment of the reset key 60 and/or of the code modification 62.

The head 14 may have a sensor 64 and/or a sensor control 66 as shown in FIGS. 1-5. The sensor 64 of the head 14 may detect whether the head 14 is attached to the article. Further, the sensor 64 may detect a tampering with and/or a destruction of the article. The sensor control 66 may be used to control a way in which the sensor 64 detects the article and/or to control a sensitivity and/or an operation of the sensor 64 as used with the article. A removal of the head 14 from the article, the tampering with the head 14 and/or the destruction of the head 14 and/or of the article may trigger the sensor 64 to effect the alarm event in the head 14 and/or in the alarm box 12. It should be understood that the sensor 64 and/or the sensor control 66 may be any sensor and/or control as known to one having ordinary skill in the art. The present invention should not be deemed as limited to a specific embodiment of the sensor 64 and/or of the sensor control 66.

The head 14 may have a radio transmitter 68 as shown in FIGS. 2-4. The radio transmitter 68 of the head 14 may be used to transmit the radio transmission from the head 14 to the alarm box 12. The radio transmission from the head 14 may have information relating to, for example, the status of the alarm event and/or the status of the alarm state of the head 14 and/or of the article and/or a location of the head 14 and/or of the article. The radio transmitter 68 may be any transmitter for transmitting the radio transmission. It should be understood that the radio transmitter 68 of the head 14 may be any means for transmitting the radio transmission as known to one having ordinary skill in the art. The present invention should not be deemed as limited to a specific embodiment of the radio transmitter 68.

The head 14 may have a radio transceiver 76 as shown in FIGS. 4 and 5. The radio transceiver 76 of the head 14 may be used to transmit and/or to receive a radio transmission to and/or from the alarm box 12. The radio transmission to and/or from the alarm box 12 may have information relating to, for example, the status of the alarm event, the status of the alarm state, the status of the alarm box 12, the status of the head 14 and/or the status of the article and/or a location of the head 14 and/or of the article. The radio transceiver 76 may also transmit and/or may receive information that disarms and/or alarms the systems 8, 10. The radio transceiver 76 may be any transceiver for transmitting and/or for receiving the radio transmission. It should be understood that the radio transceiver 76 of the head 14 may be any means for transmitting and/or for receiving the radio transmission as known to one having ordinary skill in the art. The present invention should not be deemed as limited to a specific embodiment of the radio transceiver 76.

The head 14 may have a reset decoder 72 as shown in FIG. 4. The reset decoder 72 of the head 14 may be used to decode the reset key 30 that may be received from the alarm box 12 through the transmitting medium and/or from the radio transmission in the event that the alarm event is disarmed and/or reset from the alarm box 12. The reset decoder 72 may also receive and/or may decode the code modification 32 received from the alarm box 12 through the transmitting medium and/or from the radio transmission in the event the alarm event is disarmed and/or reset from the alarm box 12. It should be understood that the reset decoder 72 of the head 14 may be any means for decoding the reset code 30 and/or the code modification 32 as known to one having ordinary skill in the art. The present invention should not be deemed as limited to a specific embodiment of the reset decoder 72.

The head 14 may have a data management system 78 as shown in FIG. 5. The data management system 78 of the head 14 may be used to manage data sent and/or received to and/or from the alarm box 12 relating to the inventory codes 40, the alarm state, the alarm event, the computer 82 and/or the control software 84. It should be understood that the data management system 78 of the head 14 may be any means for managing data as known to one having ordinary skill in the art. The present invention should not be deemed as limited to a specific embodiment of the data management system 78.

In an embodiment, as shown in FIG. 1, the article may be securely attached to the head 14. The head 14 may be electrically connected to the article to power the article. The fence driver 24 of the alarm box 12 may be adjusted to create the zone with a desired perimeter around the fence driver 24. The system 2, as shown in FIG. 1, may be armed to enter the alarm event when the head 14 and/or the article are in a position outside the perimeter of the zone. The head 14 and/or the article may then be placed on the display for the article. The power management system 20 of the alarm box 12 may power the head 14, the article and/or charge one or more of the batteries in the head 14 and/or in the article while the head 14 and/or the article are located in a position on the display stand.

A consumer may remove the head 14 and/or the article and/or may transport the head 14 and/or the article away from the display stand. While in the zone, the fence detector 54 of the head 14 may detect the presence of the transmitting medium being transmitted by the alarm box 12. While outside the zone, the fence detector 54 may detect the absence of the transmitting medium triggering the alarm event and the alarm, sounding the horn 56 and/or enabling the visual alert 58. The alarm of the head 14, the horn 56 and/or the visual alert 58 may convey to the consumer that the article and/or the head 14 is located in a restricted area of the store. The reset key 60 may be input into the head to deactivate the alarm event and/or to re-arm the head and/or the system 2. Alternatively, the consumer may keep the article and/or the head 14 within the zone but may attempt to remove the head 14 from the article. The attempted removal of the head 14 from the article may trigger the alarm event, may trigger the alarm, may sound the horn 56 and/or may activate the visual alert 58. The reset key 60 may be input into the head to deactivate the alarm event and/or to re-arm the head 14 and/or the system 2.

In an embodiment, as shown in FIG. 2, upon removal and/or arrival of the head 14 and/or article in a position inside and/or outside of the zone and/or upon triggering of the sensor 64, the radio transmitter 68 of the head 14 may be set to transmit the radio transmission to the radio receiver 34 of the alarm box 12 that may trigger the alarm event, may trigger the alarm of the alarm box 12, may sound the horn 26 of the alarm box 12, may enable the visual alert 28 of the alarm box 12, may trigger the alarm of the head 14, may sound the horn 56 of the head 14 and/or may activate the visual alert 58 of the head 14. The reset key 30 and/or the code modification 32 of the alarm box 12 may be input into the alarm box 12 that may result in a change in the transmitting medium. The change in the transmitting medium may disable the alarm event at the alarm box 12 and/or which may be received at the head 14 by the fence detector 54 disabling the alarm of the head 14, the alarm event at the head 14, the horn 56 and/or the visual alert 58. Alternatively, the reset key 60 and/or the code modification 62 of the head 14 may be input into the head 14 resulting in a transmission from the radio transmitter 68 of the head 14 to the radio receiver 34 of the alarm box 12. The alarm event may then be disabled at the alarm box 12 and/or at the head 14.

In an embodiment as shown in FIG. 3, after the alarm event has been triggered, the head 14 may be connected to the alarm box 12 via the wired bypass 36. The reset key 30 and/or the code modification 32 may be transmitted to the reset decoder 72 of the head 14 via the wired bypass 36 which may disable the alarm event and/or may change may change the electronic key. In an embodiment, the reset key 30 and/or the code modification 32 may be transmitted to the reset decoder 72 of the head 14 via the transmitting medium. In an embodiment, the fence control 74 of the head 14 may be used to change the perimeter of the zone by way of a radio communication between the radio transmitter 68 and the radio receiver 34.

In an embodiment, as shown in FIG. 4, the alarm box 12 and the head 14 may send and/or may receive two-way communications to wirelessly secure and/or to wirelessly monitor the article via the radio transceivers 38, 76. One or more functions performed by the head 14 may be controlled by the head 14 and/or by the alarm box 12. One or more functions performed by the alarm box 12 may be controlled by the alarm box 12 and/or by the head 14. One or more of the functions may be, for example, arming and/or re-arming of the alarm of the alarm box 12, arming and/or re-arming of the alarm of the head, disarming the alarm event, disabling the horns 26,56, disabling the visual alerts 28, 58, modifying properties of the zone, modifying a way in which the fence detector 54 operates, and/or the like. In an embodiment, the fence detector 54 may be set to trigger the alarm event when the head 14 is located in a position inside the zone. In an embodiment, the fence detector 54 may be set to trigger the alarm event when the head 14 is located in a position outside of the zone.

In an embodiment, as shown in FIG. 5, the alarm box 14 may be connected to the computer 82 via the data connection 86. The control software 84 may be used to control one or more of the functions of the alarm box 12, to control one or more of the functions of the head 14, and/or to track the inventory with the inventory codes 40. In an embodiment, the control software 84 may be used to set the alarm state, to arm the system 10, to monitor the location of one or more of the heads 14, to disable the alarm event, to re-arm the system 10, to record data related to the system 10 and/or to notify security personnel of the location of one or more of the heads 14.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A system for wirelessly securing an article, the system comprising:
an alarm box having a fence driver, a receiver, a first alerting means, a reset key and a power distribution system wherein the fence driver creates a zone defined by a transmitting medium having a carrier signal wherein the zone extends to a perimeter around the fence driver wherein the receiver receives a communication relating to an alarm event wherein the first alerting means provides a signal indicative of the alarm event to the system; and
a head having a fence detector, a transmitter, a second alerting means, a sensor and a power management system wherein the head is attached to the article wherein the fence detector detects a presence of the carrier signal of the transmitting medium wherein the sensor detects a detachment of the head from the article wherein a detection of an absence of the carrier signal of the transmitting medium by the fence detector initiates the alarm event wherein a detection of the detachment of the head from the article by the sensor initiates the alarm event wherein the transmitter of the head communicates the alarm event to the receiver of the alarm box wherein the second alerting means of the head provides a signal indicative of the alarm event.

2. The system of claim 1 further comprising:
a battery connected to the power management system wherein the battery provides power to the head.

3. The system of claim 1 further comprising:
a visual indicator associated with the alarm box wherein the visual indicator provides a visual signal indicative of the alarm event.

4. The system of claim 1 further comprising:
an audible indicator associated with the head wherein the audible indicator provides an audio signal indicative of the alarm event.

5. The system of claim 1 wherein the reset key of the alarm box is modified by a code modification.

6. The system of claim 1 wherein the carrier signal of the transmitting medium is modified with frequency hopping.

7. The system of claim 1 further comprising:
means for adjusting a distance between the fence driver of the alarm box and the perimeter of the zone.

8. The system of claim 1 further comprising:
a reset key associated with the head wherein the reset key terminates the alarm event.

9. The system of claim 1 further comprising:
a wired bypass associated with the alarm box wherein the wired bypass terminates the alarm event.

10. A system for wirelessly monitoring an article, the system comprising:
an alarm box having a radio transceiver, a first alerting means and a computer interface wherein the radio transceiver communicates information relating to an alarm event wherein the first alerting means provides a signal indicative of the alarm event to the system via the computer interface;
a head having a radio transceiver, a second alerting means and a sensor wherein the head is attached to the article wherein the sensor detects a detachment of the head from the article wherein detection of the detachment of the head from the article by the sensor triggers the alarm event wherein the radio transceiver of the head communicates the alarm event with the radio transceiver of the alarm box wherein the second alerting means provides a signal indicative of the alarm event; and
a computer connected to the computer interface of the alarm box.

11. The system of claim 10 further comprising:
control software associated with the computer wherein the control software monitors the alarm event.

12. The system of claim 10 further comprising:
a sensor control associated with the head wherein the sensor control adjusts a sensitivity of the sensor.

13. The system of claim 10 further comprising:
a power management system associated with the head wherein the power management system powers the head.

14. The system of claim 10 further comprising:
an inventory code associated with the alarm box wherein the inventory code corresponds with the head.

15. The system of claim 10 further comprising:
a data management system associated with the head that manages information communicated between the radio transceiver of the alarm box and the radio transceiver of the head.

16. A method for wirelessly securing an article, the method comprising the steps of:
providing a fence driver that creates a zone defined by a transmitting medium having a carrier signal wherein the zone extends to a perimeter around the fence driver;
attaching a head to the article wherein the head has a fence detector, an alerting means and a sensor wherein the fence detector detects a presence of the carrier signal of the transmitting medium and the sensor detects an attachment of the head to the article wherein a detection of the presence of the carrier signal of the transmitting medium by the fence detector initiates an alarm event wherein a detection of a detachment of the head from the article by the sensor initiates the alarm event; and
activating the fence detector and the sensor.

17. The method of claim 16 further comprising the step of:
adjusting a distance between the fence driver and the perimeter of the zone.

18. The method of claim 16 further comprising the step of:
terminating the alarm event with a reset key associated with the head.

19. The method of claim 16 further comprising the step of:
providing power to the article with a battery associated with the head.

20. The method of claim 16 further comprising the step of:
modifying a frequency of the carrier signal.
